(19) United States
(12) Patent Application Publication
(10) Pub. No.: US 2020/0148230 A1
(43) Pub. Date: May 14, 2020

(54) System and Method for the Automated Maneuvering of an Ego Vehicle

(71) Applicant: Bayerische Motoren Werke Aktiengesellschaft, Muenchen (DE)

(72) Inventors: Michael EHRMANN, Karlsfeld (DE); Robert RICHTER, Muenchen (DE)

(21) Appl. No.: 16/733,432

(22) Filed: Jan. 3, 2020

Related U.S. Application Data
(63) Continuation of application No. PCT/EP2018/066847, filed on Jun. 25, 2018.

(30) Foreign Application Priority Data
Jul. 4, 2017 (DE) 10 2017 211 387.1

(51) Int. Cl. B60W 60/00; G06K 9/00

(52) U.S. Cl. CPC B60W 60/0027; G06K 9/00805; B60W 2554/408; G05D 1/0231; B60W 2420/42; B60W 2420/52; B60W 2420/54; B60W 2556/45

(57) ABSTRACT

A system for automated maneuvering of an ego vehicle includes: a recognition device configured to recognize a moving object in the surroundings of the ego vehicle and to assign the object to a specific object classification; a control device coupled to the recognition device, the control device being configured to retrieve behavior parameters for the recognized object classification from a behavior database, the behavior parameters having been determined by a method in which moving objects are classified using machine learning and are tagged on the basis of specific behavior patterns; and a maneuver planning unit coupled to the control device, the planning unit being configured to plan and execute a driving maneuver of the ego vehicle on the basis of the retrieved behavior parameter.

### CROSS REFERENCE TO RELATED APPLICATIONS

This application is a continuation of PCT International Application No. PCT/EP2018/066847, filed Jun. 25, 2018, which claims priority under 35 U.S.C. § 119 from German Patent Application No. 10 2017 211 387.1, filed Jul. 4, 2017, the entire disclosures of which are herein expressly incorporated by reference.

### BACKGROUND AND SUMMARY OF THE INVENTION

The invention relates to a system and a method for automated maneuvering of an ego vehicle.

Driver assistance systems are known from the prior art (for example, DE 10 2014 211 507), which can plan and perform improved driving maneuvers by way of items of information, for example, vehicle type (passenger automobile/truck) or speed (slow/fast) about other road users. In this case, the items of information are provided to one another by the road users.

In these driver assistance systems known from the prior art, the advantages, for example, improved traffic flow and enhanced safety of the driving maneuver, can only be applied, however, if the other road users provide the items of information required for the driving maneuver planning.

However, it would be desirable to be able to carry out a situation-specific driving maneuver planning even without the items of information of other road users.

It is therefore the object of the invention to provide a system for automated maneuvering of an ego vehicle, which at least partially overcomes the disadvantages of the driver assistance systems known in the prior art.

A first aspect of the invention relates to a system for automated maneuvering of an ego vehicle, wherein the system comprises:
a recognition device, which is configured to recognize a movable object in the surroundings of the ego vehicle and to assign it to a defined object classification;
a control device coupled to the recognition device, which is configured to retrieve behavior parameters of the recognized object classification from a behavior database, wherein the behavior parameters have been ascertained by a method in which movable objects are classified by way of machine learning and attributed on the basis of specific behavior patterns; and
a maneuver planning unit coupled to the control device, which is configured to plan and perform a driving maneuver of the ego vehicle on the basis of the retrieved behavior parameters.

A second aspect of the invention relates to a method for automated maneuvering of an ego vehicle, wherein the method comprises:
recognizing a movable object in the surroundings of the ego vehicle and assigning the movable object to a defined object classification;
retrieving behavior parameters of the recognized object classification from a behavior database, wherein the behavior parameters have been ascertained by a method in which movable objects are classified by means of machine learning and attributed on the basis of specific behavior patterns; and
planning and performing a driving maneuver of the ego vehicle on the basis of the retrieved behavior parameters.

An ego vehicle or a vehicle in the meaning of the present document is to be understood as any type of vehicle in which persons and/or goods can be transported. Possible examples thereof are: motor vehicle, truck, motorcycle, bus, boat, aircraft, helicopter, streetcar, golf cart, train, etc.

The term “automated maneuvering” is to be understood in the scope of the document as driving having automated longitudinal or lateral control or autonomous driving having automated longitudinal and lateral control. The term “automated maneuvering” comprises automated maneuvering (driving) having an arbitrary degree of automation. Exemplary degrees of automation are assisted, partially automated, highly automated, or fully automated driving. These degrees of automation were defined by the Bundesanstalt fur Straβenwesen [Federal Highway Research Institute] (BASt) (see BASt publication “Forschung kompakt” [compact research], issue 11/2012). In assisted driving, the driver continuously carries out the longitudinal or lateral control, while the system takes over the respective other function in certain limits. In partially automated driving (PAD), the system takes over the longitudinal and lateral control for a certain period of time and/or in specific situations, wherein the driver has to continuously monitor the system as in assisted driving. In highly automated driving (HAD), the system takes over the longitudinal and lateral control for a certain period of time without the driver having to continuously monitor the system; however, the driver has to be capable within a certain time of taking over the vehicle control. In fully automated driving (FAD), the system can automatically manage the driving in all situations for a specific application; a driver is no longer required for this application. The above-mentioned four degrees of automation according to the definition of the BASt correspond to SAE levels 1 to 4 of the norm SAE J3016 (SAE—Society of automotive engineering). For example, highly-automated driving (HAD) corresponds to level 3 of the norm SAE J3016 according to the BASt. Furthermore, SAE level 5 is provided as the highest degree of automation in SAE J3016, which is not included in the definition of the BASt. SAE level 5 corresponds to driverless driving, in which the system can manage all situations automatically like a human driver during the entire journey; a driver is generally no longer required.

The coupling, for example, the coupling of the recognition device and/or the maneuver planning unit to the control unit, means a communicative connection in the scope of the present document. The communicative connection can be wireless (for example, Bluetooth, WLAN, mobile radio) or wired (for example, by use of a USB interface, data cable, etc.).

A movable object in the meaning of the present invention is, for example, a vehicle (see definition above), a bicycle, a wheelchair, a human, or an animal.

With the aid of the recognition device, a movable object located in the surroundings of the ego vehicle can be recognized and classified in an object classification. The recognition of a movable object can be performed with the aid of known devices, for example, a sensor device. In this case, the recognition device can differentiate between movable and immovable objects.

The object classification can comprise various features, which comprise different degrees of detail, for example, the type of object (vehicle, bicycle, human, . . . ), the type of vehicle (truck, passenger automobile, motorcycle, . . . ), the vehicle class (compact car, midrange car, tanker truck, moving truck, electric vehicle, hybrid vehicle, . . . ), the producer (BMW, VW, Mercedes-Benz, . . . ), the vehicle properties (license plate, type of engine, color, stickers, . . . ). In any case, the object classification is used to describe the movable object on the basis of defined features. An object classification then describes a defined feature combination in which the movable object can be classified. If it has been recognized by the recognition device that it is a movable object, this movable object is classified in an object classification. For this purpose, measurement data are collected, analyzed, and/or stored with the aid of the recognition device. Such measurement data are, for example, surroundings data, which are recorded by a sensor device of the ego vehicle. Additionally or alternatively, measurement data from memories installed in or on the automobile or vehicle-external memories (for example, server, cloud) can also be used to classify the recognized movable object in an object classification. The measurement data correspond in this case to the above-mentioned features of the movable object. Examples of such measurement data are: the speed of the movable object, the distance of the movable object from the ego vehicle, the orientation of the movable object in relation to the ego vehicle, and/or the dimension of the movable object.

The recognition device can be arranged in and/or on the ego vehicle. Alternatively, a part of the recognition device, for example, a sensor device, can be arranged in and/or on the ego vehicle and another part of the recognition device, for example, a corresponding control unit and/or a processing unit, can be arranged outside the ego vehicle, for example, on a server.

According to one embodiment, the recognition device is configured to assign the movable object to an object classification by analyzing surroundings data, which have been ascertained by a sensor device of the ego vehicle. The sensor device comprises one or more sensors, which are designed to recognize the vehicle surroundings. The sensor device provides corresponding surroundings data and/or processes and/or stores them.

In the scope of the present document, a sensor device is understood as a device which comprises at least one of the following units: ultrasonic sensor, radar sensor, lidar sensor, and/or camera, preferably high-resolution camera, thermal imaging camera, Wi-Fi antenna, thermometer.

The above-described surroundings data can originate from one of the above-mentioned units or from a combination of a plurality of the above-mentioned units (sensor data fusion).

If a movable object has been recognized in the surroundings of the ego vehicle and has been assigned to a defined object classification, behavior parameters with respect to the recognized object classification are retrieved from a behavior database for the maneuver planning.

The planning and performance of the driving maneuver of the ego vehicle is thus augmented by a specific behavior, which varies in dependence on the object classification (for example, passenger automobile or vehicle transporting hazardous material or BMW i3). The maneuver planning and maneuver performance can thus take place in a targeted manner depending on the recognized and assigned object, wherein the traffic flow is improved and the safety of the occupants is increased.

A control device coupled to the recognition device retrieves behavior parameters of the recognized object classification from a behavior database.

The term “behavior database” is to be understood as a unit which receives, processes, stores and/or emits behavior data. The behavior database preferably comprises a transmission interface, via which the behavior data can be received and/or transmitted. The behavior database can be arranged in the ego vehicle, in another vehicle, or outside vehicles, for example, on a server or in the cloud.

The behavior database contains separate behavior parameters for each object classification. Behavior parameters in this case mean parameters which describe a defined behavior of the movable object, for example, the behavior that a VW Lupo does not drive faster than a defined maximum speed, or a vehicle transporting hazardous material (hazardous material truck) regularly stops at a railway crossing, or a bicycle travels one-way streets in the opposite direction, or that a wheelchair travels on the roadway if the sidewalk is obstructed.

The behavior parameters which are stored in the behavior database have been ascertained by a method in which movable objects are first classified and then attributed on the basis of specific behavior patterns with the aid of machine learning methods.

The term “specific behavior pattern” means a repeating behavior which occurs with respect to a specific situation. The specific situation can comprise, for example, a defined location and/or a defined time. The specific behavior patterns therefore have to be filtered out of the routine behavior of movable objects. Examples of such specific behavior patterns of the movable object are: “stopping at railway crossing”, “active turn signal during an overtaking procedure”, “maximum achievable speed/acceleration”, “lengthened braking distance”, “sluggish acceleration”, “frequent lane changes”, “reduced distance to a forward movable object (for example, preceding vehicle)”, “use of headlight flashers”, “speeding”, “abrupt braking procedure”, “leaving the roadway”, “traveling on a defined region of the roadway”, etc.

The specific behavior patterns are analyzed for the respective classified movable object for the ascertainment of the behavior parameters. Attributes for the respective classified movable object are then defined from the analysis. A certain number of attributes is then assigned to the respective object classification, and optionally stored and/or made available.

Systems having a recognition device (preferably a recognition device which comprises a sensor device) and a control device, as described above, are used by various vehicles for the classification of the objects, i.e., the classification of the movable objects into defined object classifications. That is, the behavior parameters stored in the behavior database thus do not exclusively originate from the ego vehicle, but rather can originate from the corresponding systems of many different vehicles.

To define specific behavior patterns and attribute the classified movable object accordingly, according to one embodiment, measurement data with respect to the classified movable object are analyzed. The analysis takes place by means of machine learning methods.

Alternatively, measurement data with respect to the classified movable object can be measured and analyzed to define specific behavior patterns and attribute the classified movable object accordingly. For this purpose, in the case of a defined measurement behavior, a defined measured variable is preferably measured and/or analyzed and/or stored with respect to the classified movable object.

The measurement data, the analysis of which finally results in the behavior parameters, can originate in this case from a measurement device of a vehicle, for example, of the ego vehicle itself, or from measurement devices of multiple different vehicles or from an external data source. Such a measurement device is a device which ascertains and/or stores and/or outputs data with respect to movable objects. For this purpose, the measurement device can comprise an (above-described) sensor device. Examples of an external data source are: accident statistics, breakdown statistics, weather data, navigation data, vehicle specifications, etc.

According to one embodiment, the measurement data are ascertained by a measurement device of a vehicle and/or provided by a vehicle-external data source.

The measurement data and/or the analyzed measurement data can be stored in a data memory. This data memory can be located in the ego vehicle, in another vehicle, or outside a vehicle, for example, on a server or in the cloud. The data memory can be accessed, for example, by multiple vehicles, so that a comparison of the measurement data and/or the analyzed measurement data can take place.

Examples of measurement data comprise speed curve, acceleration or acceleration curve, ratio of movement times to stationary times, maximum speed, lane change frequency, braking intensity, breakdown frequency, breakdown reason, route profile, brake type, transmission type, weather data, etc.

The control device can comprise a processing unit for analyzing the measurement data. The processing unit can be located in this case in the ego vehicle, in another vehicle, or outside a vehicle, for example, on the server or in the cloud. The processing unit can be coupled to the data memory, on which the measurement data and/or the analyzed measurement data are stored, and can access these data.

A defined behavior of the classified movable object is filtered out from the measurement data by using machine learning algorithms, which are computed, for example, on the processing unit. The attributes for the classified movable object are then developed from this defined behavior.

This is to be explained hereafter on the basis of an example, in which a movable object has been classified as a hazardous material truck by a test vehicle. A sign which indicates a railway crossing on an upcoming route section of the test vehicle is recognized by the recording and processing of the measurement data of the ultrasonic sensors and/or the high-resolution camera of the test vehicle. The presence of an upcoming railway crossing can be verified by the comparison to map data (for example, a high-accuracy map). The way in which the hazardous material truck behaves at the railway crossing is recorded by the sensor device of the test vehicle. This behavior is compared with application of machine learning algorithms to the behavior of other trucks, from which a specific behavior is derived with respect to the railway crossing for the hazardous material truck. The object classification “hazardous material truck” is then assigned, for example, the attribute “stopping at railway crossing”.

A further example of measurement data from which specific behavior patterns can be derived is the license plate of a vehicle (for example, passenger automobile, truck, motorcycle). Different attributes can thus be assigned to a passenger automobile originating from France than to a passenger automobile originating from Germany. One possible attribute of a passenger automobile originating from France is, for example, “active turn signal during the overtaking procedure”.

The specific behavior pattern of an aggressive driving behavior can be defined by measurement data which specify the distance of the vehicles from one another, the changes of the distances between the vehicles, the number of the lane changes, the use of the headlight flashers, the acceleration and braking behavior, and speeding. If the movable object has been classified as a “red Ferrari”, the object classification “red Ferrari” is thus assigned attributes such as “less distance between vehicles”, “frequent speeding”, etc.

The linkage of the specific behavior patterns to the respective object classifications then results in the behavior parameters which are stored in the behavior database.

The maneuver planning unit of the system for automated maneuvering of the ego vehicle receives the behavior parameters via the control device in dependence on the recognized object classification and incorporates them into the driving maneuver planning and driving maneuver performance.

If the recognition device recognizes, for example, a vehicle in front of the ego vehicle and assigns it to the object classification “hazardous material truck”, the driving maneuver of the ego vehicle is thus changed because of the behavior parameter “stopping at railway crossing” in such a way that an increased safety distance is maintained to the preceding truck.

If the recognition device recognizes, for example, a vehicle in front of the ego vehicle and assigns it to the object classification “40-ton truck”, the vehicle components of the ego vehicle are thus preset because of the behavior parameter “lengthened braking distance” in such a way that an emergency evasion maneuver or an emergency stopping maneuver can be initiated rapidly. For this purpose, for example, the brake booster is “pre-tensioned”. Furthermore, the vehicle following the ego vehicle can also be assigned to an object classification via the recognition device and the decision between emergency evasion maneuver and emergency stopping maneuver can be made on the basis of the behavior parameters which are associated with this object classification.

If a vehicle preceding the ego vehicle was recognized and assigned as a “red Ferrari”, the maneuver planning unit can thus provide increasing the distance to this vehicle and possibly changing the lane.

A better adaptation of road users to one another, in particular in a mixed-class traffic scenario (manual, partially autonomous, and autonomous vehicles) is achieved using the above-described embodiments of the system and/or method for automated maneuvering of an ego vehicle. Furthermore, an identification of road users as “troublemakers” or as a potential hazard for possibly autonomously driving vehicles. Precise maneuver planning is thus possible based on the specific behavior of certain vehicle types. An individual driving assistance function, for example, maintaining distance, can be varied depending on the object classification. Furthermore, the driving behavior of an autonomously driving vehicle of a specific producer can be analyzed and estimated by the above-described embodiments of the system and/or the method for automated maneuvering of an ego vehicle. This in turn permits an individual reaction of the driving maneuver of the ego vehicle.

According to one embodiment, a vehicle comprises a system for automated maneuvering of an ego vehicle according to one of the above-described embodiments.

The above statements on the system according to the invention for automated maneuvering of an ego vehicle according to the first aspect of the invention also apply accordingly to the method for automated maneuvering of an ego vehicle according to the second aspect of the invention and vice versa; advantageous exemplary embodiments of the method according to the invention correspond to the described advantageous exemplary embodiments of the system according to the invention. Advantageous exemplary embodiments of the method according to the invention which are not explicitly described at this point correspond to the described advantageous exemplary embodiments of the system according to the invention.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 schematically shows a system for automated maneuvering of an ego vehicle according to one embodiment.

FIG. 2 schematically shows a system for automated maneuvering of an ego vehicle according to one embodiment.

### DETAILED DESCRIPTION OF THE DRAWINGS

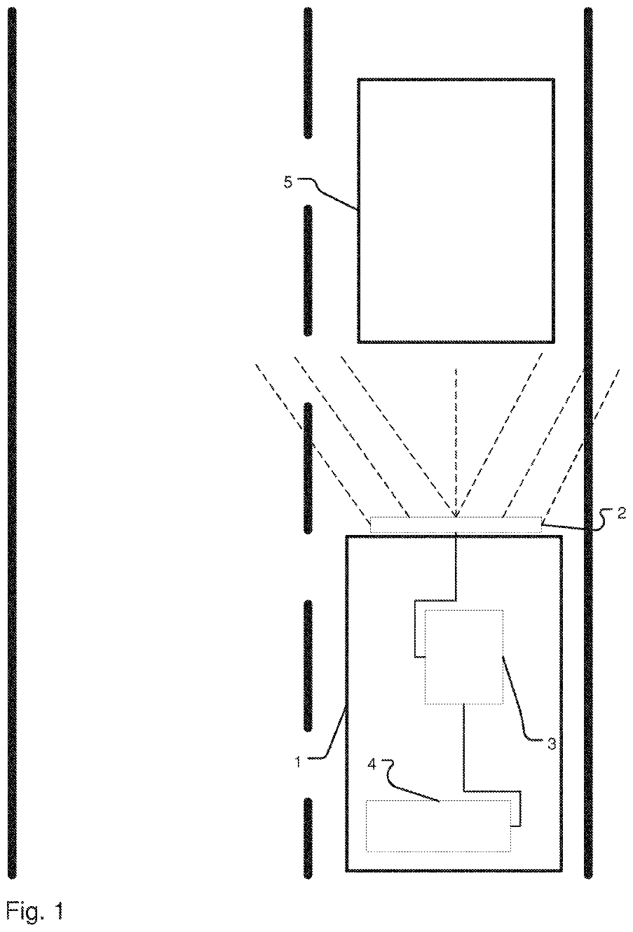

An ego vehicle 1 is shown in FIG. 1, which is equipped with a sensor device 2 and a control unit 3 connected to the sensor device 2. Movable objects in the surroundings of the ego vehicle 1 can be recognized and assigned to a defined object classification using the sensor device 2. A vehicle 5 in front of the ego vehicle is shown in FIG. 1. With the aid of the sensor device 2, which comprises at least one ultrasonic sensor, one radar sensor, and one high-resolution camera, the ego vehicle 1 is initially capable of recognizing that a vehicle 5 is located in the front surroundings of the ego vehicle 1. Furthermore, the sensor device 2 is capable of acquiring and analyzing defined features of the vehicle 5, for example, type designation, engine displacement, vehicle size and/or vehicle dimension, and present vehicle speed. On the basis of the analysis of the acquired features of the vehicle 5, the vehicle 5 is assigned the object classification “MINI One First” (referred to hereafter as MINI). The found object classification “MINI” is then transmitted to the control unit 3. The control unit 3 thereupon retrieves the behavior parameters, which correspond to the recognized object classification “MINI”, from a behavior database. The behavior of the vehicle 5 is described by the behavior parameters. The behavior parameters stored in the behavior database for the “MINI” are: sluggish acceleration (acceleration 0-100: 12.8 seconds), maximum speed of 175 km/h, vehicle length of 3900 mm, vehicle width of 1800 mm, vehicle height of 1500 mm.

The ego vehicle 1 moreover comprises a maneuver processing unit 4, which plans the next driving maneuver or the next driving maneuvers of the ego vehicle 1 with the aid of the behavior parameters and activates the corresponding vehicle components to perform them. If a target speed of the ego vehicle 1 is set which is greater than the maximum speed of the vehicle 5, the driving maneuver planning will comprise an overtaking procedure of the vehicle 5. If the instantaneous speed of the ego vehicle 1 is far above the maximum speed of the vehicle 5, the overtaking procedure is thus initiated early, i.e., with significant distance to the vehicle 5.

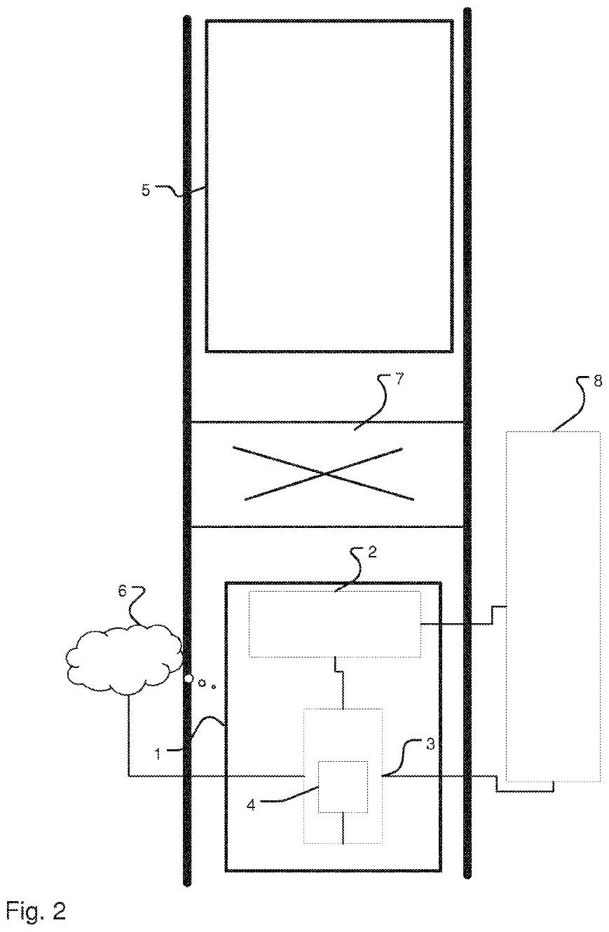

An ego vehicle 1 having a recognition device 2 and a control unit 3, in which a maneuver planning unit 4 is arranged in an integrated manner, is shown in FIG. 2. For the driving maneuver planning and performance of the ego vehicle 1, the control unit 3 retrieves behavior parameters from a behavior database 6. It is described hereafter how the behavior parameters are defined. This will be described on the basis of the example of the ego vehicle 1. The behavior parameters stored in the behavior database 6 do not exclusively have to originate from a vehicle or from an analyzed driving situation, however, but rather are typically parameters which are analyzed with the aid of a plurality of vehicles and/or a plurality of driving situations and are subsequently stored in the behavior database 6.

It is presumed in the following description that the behavior database 6 is stored in the cloud and the ego vehicle 1 can gain access thereto. Alternatively, the behavior database 6 can be stored locally in the ego vehicle 1 or any other vehicle.

For the definition of the behavior parameters, movable objects are classified by machine learning algorithms and attributes are assigned thereto in dependence on the specific behavior thereof. For the example of the ego vehicle 1 according to FIG. 2, firstly the preceding vehicle 5 is recognized as a hazardous material truck by the recognition device 2. This takes place, among other things, by way of the acquisition of warning signs on the rear side of the truck and also the dimension and the speed of the truck. Moreover, it is acquired via the recognition device 2 of the ego vehicle 1 that a railway crossing is located on the upcoming route section. On the basis of the marking 7 located on the road and a sign (not shown) located on the edge of the road and also, optionally, on the basis of additional items of information from map data, which have been transmitted, for example, to the control unit 3 or the recognition unit 2 of the ego vehicle 1 via the backend and/or the cloud and/or a server, the recognition device 2 recognizes that a railway crossing is present on the upcoming route section.

The information “hazardous material truck” and “railway crossing” are transmitted by the recognition device 2 and/or the control unit 3 to a vehicle-external processing unit 8.

While the ego vehicle 1 travels farther on the road having the upcoming railway crossing, the behavior of the preceding truck is acquired (“observed”) by the recognition device 2 and possibly by the control unit 3 and transferred to the processing unit 8. The present behavior of the truck 5 driving in front of the ego vehicle 1 is compared to the behavior of other trucks in the processing unit 8. The behavior of other trucks is stored, for example, locally in the ego vehicle 1, in the cloud 6, in the processing unit 8, or another external memory source which the processing unit 8 can access. The comparison of the behavior of various trucks to the behavior of the preceding truck 5 has the result that the truck 5 stops before the railway crossing, although there is neither a stop sign nor a traffic signal at this point. The processing unit 8 thus recognizes that the preceding truck 5 behaves differently than typical trucks. In this case, only those trucks are compared which have a similar object classification. It is now learned by way of the (non-rule-based) machine-learning algorithms (neuronal network) which conditions could have resulted in differing behavior. Finally, defined attributes are assigned to the preceding truck 5 which express the differing behavior. In the present example, a high correlation results between the attribute “truck” and “hazardous material”. On the basis of these assigned attributes, the behavior parameter “stopping before railway crossing” results for the object classification hazardous material truck. This behavior parameter is then assigned to the object classification “hazardous material truck” in the behavior database 6. A vehicle which recognizes such a hazardous material truck can then retrieve the behavior parameters stored in the behavior database 6 and plan the driving maneuver accordingly. In the driving maneuver, differently from the recognition of a typical truck, an increased safety distance is maintained in relation to the hazardous material truck to anticipate the imminent stopping of the hazardous material truck.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A system for automated maneuvering of an ego vehicle, comprising:
a recognition device, which is configured to recognize a movable object in surroundings of the ego vehicle and to assign the movable object to a defined object classification;
a control device coupled to the recognition device, which is configured to retrieve behavior parameters of the defined object classification from a behavior database, wherein the behavior parameters have been determined by a method in which movable objects are classified by machine learning and attributed on the basis of specific behavior patterns; and
a maneuver planning unit coupled to the control device, which is configured to plan and perform a driving maneuver of the ego vehicle on the basis of the retrieved behavior parameters.

2. The system according to claim 1, wherein
the recognition device is configured to assign the movable object to an object classification by analyzing surroundings data which have been determined by a sensor device of the ego vehicle.

3. The system according to claim 2, wherein
measurement data with respect to the classified movable object are analyzed for the determination of the specific behavior pattern and for the corresponding attribution of the classified movable object.

4. The system according to claim 3, wherein
the measurement data are determined by a measurement device of a vehicle and/or are provided by a vehicle-external data source.

5. A vehicle, comprising a system according to claim 1.

6. A method for automated maneuvering of an ego vehicle, the method comprising the acts of:
recognizing a movable object in the surroundings of the ego vehicle and assigning the movable object to a defined object classification;
retrieving behavior parameters of the recognized object classification from a behavior database, wherein the behavior parameters have been determined by a method in which movable objects are classified by machine learning and attributed on the basis of specific behavior patterns; and
planning and performing a driving maneuver of the ego vehicle on the basis of the retrieved behavior parameters.

7. The method according to claim 6, wherein
the movable object is assigned to an object classification by analyzing surroundings data which are determined by a sensor device of the ego vehicle.

8. The method according to claim 7, wherein
measurement data with respect to the classified movable object are analyzed for the determination of the specific behavior pattern and for the corresponding attribution of the classified movable object.

9. The method according to claim 8, wherein
the measurement data are determined by a measurement device of a vehicle and/or are provided by a vehicle-external data source.
